(19) United States
(12) Patent Application Publication
(10) Pub. No.: US 2003/0079392 A1
(43) Pub. Date: May 1, 2003

(54) Automobile registration display

(76) Inventor: Bryon K. Newman, Philadelphia, PA (US)

Correspondence Address: Bryon K. Newman, 24 N. Conestoga St., Philadelphia, PA, 19139, US

(21) Appl. No.: 09/984,105

(22) Filed: Oct. 29, 2001

(51) Int. Cl. G09F 21/04

(52) U.S. Cl. 40/661; 40/593

(57) ABSTRACT

The automobile registration display is accentually a small transparent plastics decal holder. This decal holder is made special because it has the ability to be placed on a Automobile Rear window by means of suction cups. And the holder is made in such a Way to allow a decal to be placed between the front and back of the two surfaces.

### CROSS-REFERENCES TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKROUND OF THE INVENTION

In Philadelphia, Pa. there was a large amount of Automobile tags getting Stolen. Stolen for the purpose or removing the registration from the tag and placing the Registration on their tag. A couple of years ago Pennsylvania department of Transportation came up with a new idea. Penn DOT started issuing a paper registration With two glue strips on the front. This registration was to be placed on the rear window. This was a good idea. Lowering the amount of automobile tag theft. The problem with the new registration started approximately six months after the Registration was installed. The registration became faded, wrinkled and the glue stopped Adhering to the rear window. Therefore the public is now tapping the registration in

The back window. The tape also stopped adhering to the rear window. The public is starting to use duct tape, obscuring more of the window view. I invented the Automobile registration display to allow display of the public Registration with approximately the same viewing area originally intended By Pennsylvania Department of Transportation. The Automobile Registration Display can be reused, remounted and relocated at the user discretion. This Installation requires no tape or glue. Clearing up the problem with the unsightly Duct tape in the window or the registration falling half way of the window.

### BREIF SUMMARY OF THE INVENTION

The Automobile Registration Display is made of transparent plastic, having A slit running the width of the display to allow for the insertion of the Automobile Registration. The Automobile Registration display also has rubber suction cups These suction cups are for adhering the Automobile Registration display to the Rear window.

### BRIEF DESCRIPTION OF THE SEVERAL VIEWS OF THE DRAWING

FIG. 1 is a perspective view of the automobile registration display showing my new Design;

FIG. 2 is a front view thereof;

FIG. 3 is a left side view thereof; with the right side being a mirror image;

FIG. 4 is a top view thereof; with the bottom view being a mirror image.

### DETAIL DESCRIPTION OF THE INVENTION

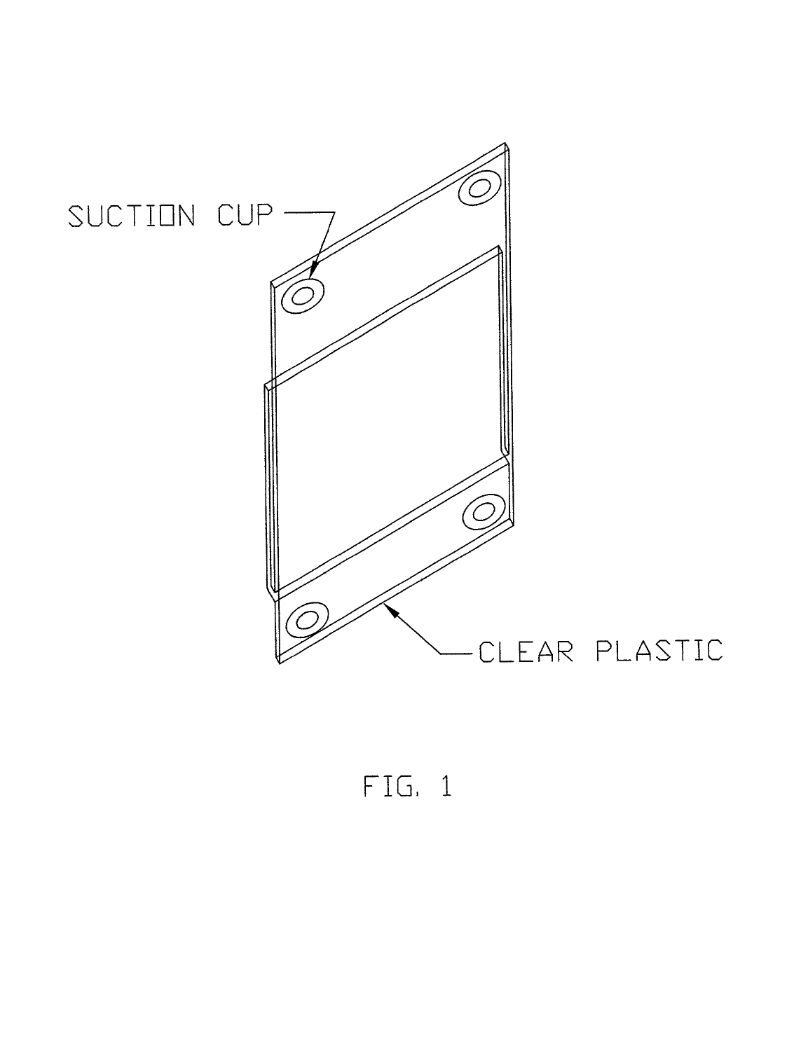

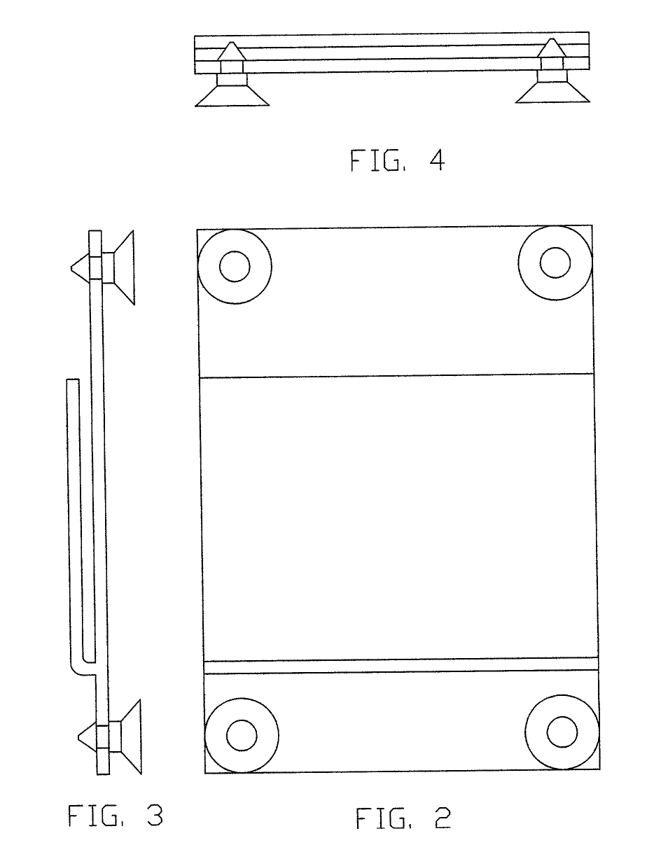

The Automobile Registration Display is made of transparent plastic and rubber Suction cups. The transparent plastic shall be molded as shown in FIG. 1 of the Patent drawing. The transparent plastic will be slotted as to hold the vehicle registration Decal. The rubber suction cups are to be affixed to the transparent plastic as shown in FIG. 1 of the patent drawing. Both the transparent plastic and the rubber suction cups Are to be secured to the rear window or the automobile, displaying the automobile Registration.

1. I clam the design of the automobile registration display excluding the suction used In this patent application to be of my own thoughts and concepts therefore this Application is being submitted to you for your approval.
